(19) United States
(12) Patent Application Publication
(10) Pub. No.: US 2026/0021968 A1
(43) Pub. Date: Jan. 22, 2026

(54) ITEM PROCESSING DEVICE

(71) Applicant: EXOTEC PRODUCT FRANCE, CROIX (FR)

(72) Inventors: Julien MOURET, MARCQ EN BAROEUL (FR); Loïc LEPILLIER, WATTRELOS (FR)

(73) Assignee: EXOTEC PRODUCT FRANCE, CROIX (FR)

(21) Appl. No.: 19/267,758

(22) Filed: Jul. 14, 2025

(30) Foreign Application Priority Data
Jul. 19, 2024 (FR) 2407979

(51) Int. Cl. B65G 1/137

(52) U.S. Cl. CPC B65G 1/1373; B65G 2201/0235

(57) ABSTRACT

A mobile item processing device a chassis, a robotic arm mounted on the chassis and provided with a gripping member at its end, the robotic arm being configured to grasp an item from and/or place an item in an internal volume of at least one container arranged in proximity to the chassis, a support structure mounted on the chassis, at least one camera fixed to the support structure.

The support structure is movable between a deployed configuration (CD) in which the camera is capable of capturing an image of the internal volume of the container, and a retracted configuration (CE) in which the item processing device occupies a smaller volume in comparison to the deployed configuration (CD).

### TECHNICAL FIELD

This description relates to the field of robotics, and in particular to robotic arms for industrial use. This description relates to an item processing device comprising a robotic arm. This description also relates to a logistics assembly comprising such an item processing device and to a raising ramp.

### BACKGROUND

In the field of logistics, it is known that an operator or a robot carries out order preparation operations which consist of manually or automatically moving items between a first container and a second container (also called “pick and place”). Typically, the first container contains inventory items and comes from a shelf of an automated storage and retrieval system (also called ASRS), and the second container is intended to contain the items of an order for delivery to a customer.

Conventionally, these “pick and place” operations are carried out at a system comprising a gripper robot. The gripper robot generally comprises a chassis permanently anchored to the ground, a robotic arm, and a gripping member which allows picking and placing the items.

To limit transfer-related fatigue and reduce order preparation time, containers may be brought to this system and then be sent on by means of a conveyor that is also permanently anchored in proximity to the gripper robot.

To identify and locate the items to be gripped, the system generally comprises a camera mounted on a supporting structure fixed to the ground so as to be positioned at a certain height and oriented towards an area through which the items pass. The system is also equipped with a computing unit for processing the camera images and controlling the gripper robot.

Another example of a system comprising a robotic arm and a gripping member is disclosed in document US 2023/0234216. In this system, the robotic arm is attached to a supporting structure that is arranged above an input conveyor carrying a first container and an output conveyor carrying a second container. The robotic arm is configured to move an item from the first container to the second container.

One can see that such systems first have the disadvantage of being bulky, which makes them difficult to transport within a warehouse and requires significant space in the warehouse where they are to be installed. Furthermore, due to anchoring them to the ground, these systems are not very flexible and do not allow easily rearranging the warehouse. Finally, the installation of electrical connections between the gripper arm, the camera, and the computing unit makes it long and costly to set up these systems.

Document US 2023/415345-A1 describes a movable device for picking and placing items, comprising a chassis provided with wheels for moving the device, a vertical support fixed to the chassis, and, associated with the vertical support, a first platform for supporting a first container, a second platform for supporting a second container, a robotic arm for picking an object from the first container and placing it in the second container, and a camera. The first platform and second platform are vertically movable along the support and each comprise a push-pull mechanism for loading and unloading a container on the device. The camera is mounted on an arm that is rotatable between a position allowing vertical movement of the platforms and a position which allows the camera to capture an image of the first container and/or of the second container. This highly automated movable device typically moves through the shelves of an ASRS to prepare an order but does not allow order preparation at a high rate.

### SUMMARY

A mobile item processing device is proposed, comprising:
a chassis,
a robotic arm mounted on the chassis and provided with a gripping member at its end, the robotic arm being configured to grasp an item from and/or place an item in an internal volume of at least one container arranged in proximity to the chassis,
a support structure mounted on the chassis,
at least one camera fixed to the support structure,
   characterized in that the support structure is movable between a deployed configuration in which the camera is capable of capturing an image of the internal volume of the container, and a retracted configuration in which the item processing device occupies a smaller volume in comparison to the deployed configuration.

The support structure may be articulated so as to pivot relative to the chassis about a first axis.

The support structure may comprise at least one support arm which comprises a first segment and a second segment, the second segment being articulated so as to pivot relative to the first segment about a second axis.

The first axis and the second axis may be parallel, the support structure comprising a first support arm and a second support arm which are parallel to each other and spaced apart along the direction of the first axis and second axis.

The support structure may comprise at least one cross-member extending between the first support arm and the second support arm along the direction of the first axis and second axis, the at least one camera preferably being attached to the at least one cross-member.

The chassis may have, in a first direction, a front side configured to face the at least one container and a rear side that is opposite the front side in the first direction, the robotic arm being mounted on the chassis such that it is closer to the front side than to the rear side, the chassis preferably having a centre of gravity that is closer to the rear side than to the front side.

The item processing device may have a depth in the first direction that is smaller when the support structure is in the retracted configuration than when it is in the deployed configuration.

The item processing device may have a height in a vertical direction that is smaller when the support structure is in the retracted configuration than when it is in the deployed configuration.

The item processing device may have a volume when the support structure is in the retracted configuration that renders it suitable for insertion into a container of parallelepipedal shape and standard dimensions, in particular 20 feet or 40 feet.

The gripping member may be a pneumatic vacuum gripper, the item processing device comprising a vacuum source arranged inside the chassis and in fluid communication with the gripping member.

The item processing device may comprise a control unit configured to control the robotic arm and to process a signal received from the at least one camera so as to identify items in the containers and/or determine the location of items in the containers, the control unit being arranged inside the chassis.

The chassis may comprise at least one lower recess and/or a pair of holes, adapted to receive the prongs of a lifting fork.

The item processing device may comprise a system of safety sensors which is configured to project a light curtain and to detect a crossing of the light curtain by an object and/or an operator.

The light curtain may comprise:
a central beam extending transversely at the rear side of the chassis which is opposite the front side in the first direction,
a pair of side beams each extending in the first direction and arranged, transversely to the first direction, on each side of the chassis.

The item processing device may comprise a protective panel mounted on the chassis at the rear side.

The item processing device may have a weight that is less than or equal to 700 kg.

According to another aspect, a logistics warehouse assembly is provided comprising an item processing device as described above and a raising ramp, the raising ramp being configured to allow a motorized vehicle to bring the at least one container in proximity to the chassis so that the robotic arm is able to grasp an item from and/or place an item in the internal volume of the container.

The logistics warehouse assembly may comprise a container arranged in proximity to the chassis of the item processing device, the at least one camera being arranged facing the bottom of the container when the support structure is in the deployed configuration.

### BRIEF DESCRIPTION OF DRAWINGS

Other features, details and advantages will become apparent from the following detailed description and from the accompanying drawings, in which:

FIG. 1 is a schematic side view of an item processing device according to this description, in which a support structure is in a deployed configuration.

FIG. 2 is a schematic side view of the item processing device of FIG. 1, in which the support structure is in a retracted configuration.

FIG. 3 is a schematic perspective view of the support structure of the item processing device of FIGS. 1 and 2, in the deployed configuration.

FIG. 4 is a partial schematic perspective view of a chassis of the item processing device of FIGS. 1 and 2.

FIG. 5 is a schematic perspective view of the item processing device of FIG. 2.

FIG. 6 is a schematic perspective view of the item processing device of FIG. 1 and of a raising ramp allowing containers comprising items to be brought in proximity to the item processing device, in particular by motorized vehicles, preferably autonomous.

FIG. 7 includes FIGS. 7a and 7b which show first stop means of the support structure.

FIG. 8 includes FIGS. 8a and 8b which show second stop means of the support structure.

FIG. 9 is a schematic top view of the item processing device of FIG. 1, showing a protective light barrier.

### DETAILED DESCRIPTION

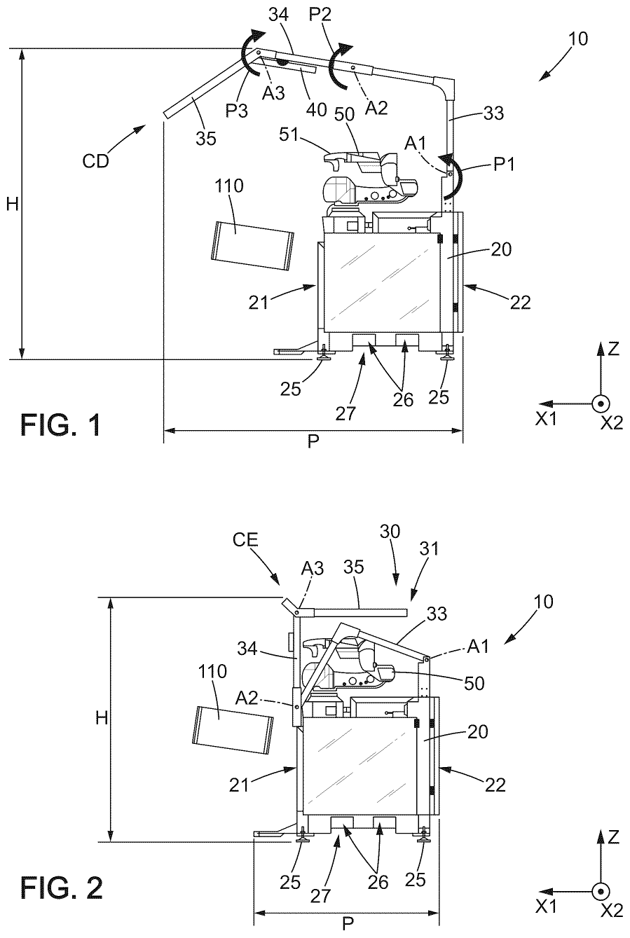

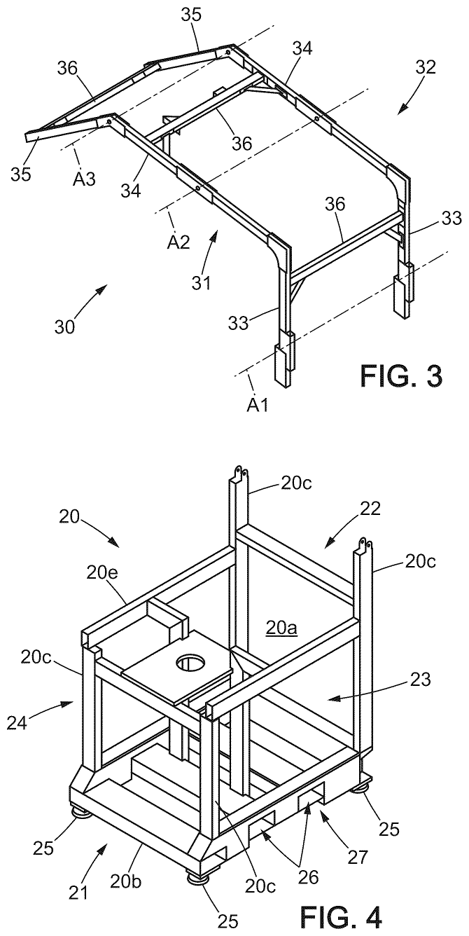

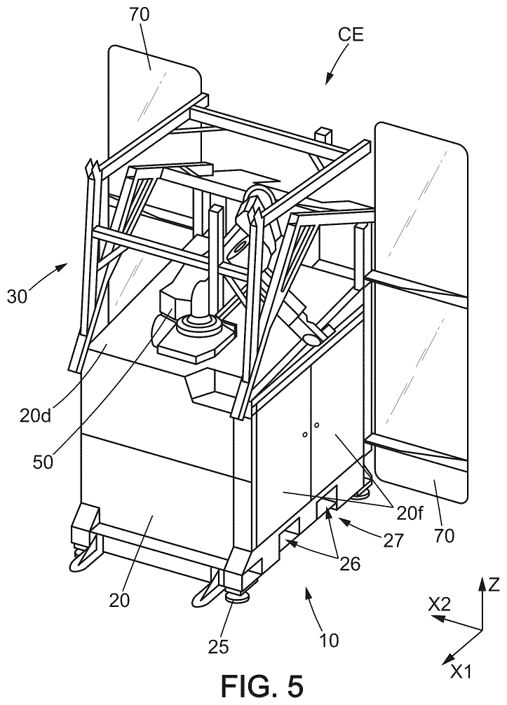

A mobile item processing device 10 is now described with reference to FIGS. 1 to 5, which comprises:
a chassis 20,
a robotic arm 50 mounted on the chassis 20 and provided with a gripping member 51 at its end, the robotic arm 50 being configured to grasp an item from and/or place an item in an internal volume of at least one container 110 arranged in proximity to said chassis 20,
a support structure 30 mounted on the chassis 20,
at least one camera 40 fixed to the support structure 30.

The item processing device is mobile and therefore may be moved about freely in a logistics warehouse, in particular by means of a forklift or a pallet truck. The device is entirely transportable, i.e. is not fixed to a permanent infrastructure such as a rail.

It is noteworthy that the support structure 30 is movable between a deployed configuration CD in which the camera 40 is able to capture an image of the internal volume of the container 110, and a retracted configuration CE in which the item processing device 10 has a smaller volume in comparison to the deployed configuration CD. In other words, the overall size of the item processing device with the support structure in the retracted configuration is reduced compared to that of the support structure in the deployed configuration. The item processing device 10 is therefore easier to transport when the support structure 30 is in the retracted configuration CE. The device is also mobile and easily transportable, which facilitates rearranging or reorganizing a warehouse. For example, it is easy to replace an operator at an order preparation station with the item processing device 10 of this disclosure, and vice versa.

The transition from the deployed configuration CD to the retracted configuration CE, and conversely from the retracted configuration CE to the deployed configuration CD, may be carried out manually, in other words in a non-motorized manner and without mechanical assistance. The design and manufacture of the processing device are thus facilitated.

The processing of an item may comprise gripping an item in a first container 110 and placing the gripped item in a second container 110, in particular for the purpose of order preparation. In other words, the robotic arm 50 may be configured to grip, via the gripping member 51, an item in the first container 110 and place it in the second container 110. The processing of items may also comprise distributing items into several containers 110, or even performing an inventory.

Each container 110 may comprise a bottom and a side wall which delimit the internal volume of the container 110. The internal volume of each container 110 may be accessible through an upper opening, preferably defined by the side wall. Each container 110 may have a parallelepipedal shape.

The chassis 20 has, in a first direction X1, a front side 21 configured to face said at least one container 110 and a rear side 22 opposite the front side 21 along the first direction X1. It is further understood that the front side 21 of the chassis 20 is configured to face one or more containers 110. The chassis 20 may have a first lateral side 23 and a second lateral side 24 which are opposite each other in a second direction X2 which is preferably perpendicular to the first direction X1.

The chassis 20 may be adapted to be placed on the ground, in particular without being permanently anchored to the ground. The chassis 20 may have a substantially parallelepiped shape. The chassis 20 may comprise one or more feet 25 intended to rest on the ground, preferably of adjustable height H.

The chassis 20 may integrate all elements which allow the item processing device 10 to operate, such as a vacuum pump, a control unit, and/or electrical wiring. Such operating elements are described in more detail below. The chassis 20 may comprise an internal housing 20a adapted to receive the operating elements of the device. In other words, the chassis 20 may be hollow, thus enabling it to receive the operating elements of the device. The chassis 20 may comprise an opening which allows access to the internal housing. The chassis 20 may comprise a door 20f which allows closing off the opening.

More particularly, the chassis 20 may comprise a lower base 20b, a plurality of vertical posts 20c, and panels extending between and supported by the vertical posts 20c. The plurality of vertical posts 20c may comprise a pair of front posts at the front of the chassis 20 and a pair of rear posts at the rear of the chassis 20. The chassis 20 may comprise an upper plate 20d on which the robotic arm 50 rests, preferably supported by the vertical posts 20c. The upper plate 20d may comprise a frame 20e secured to the vertical uprights 20c, comprising for example a pair of lateral side members arranged at each lateral side of the chassis 20 and preferably extending in the first direction X1, and a pair of central side members arranged at the front and rear of the chassis and preferably extending in the second direction X2.

The chassis 20 may comprise at least one lower recess 27 and/or a pair of holes 26, adapted to receive the prongs of a lifting fork. The lifting fork may for example be that of a pallet truck. The chassis 20 may comprise a lower recess 27 and/or a pair of holes 26 in one of the lateral sides of the chassis 20 or in each lateral side of the chassis 20. Additionally or alternatively, the chassis 20 may comprise a lower recess 27 and/or a pair of holes 26 in the front side 21 and/or the rear side 22. This configuration allows flexibility in picking up and setting down the device in a warehouse and/or in loading and unloading it from a truck. The lower recess 27 and/or the pair of holes 26 may be arranged in a lower portion of the chassis.

The robotic arm 50 may be an arm with multiple articulations, preferably an industrial robot (different from “collaborative” robots), in particular defining at least six axes of rotation and adapted to move and/or orient the gripping member 51 with six degrees of freedom. The robotic arm 50 may be mounted on an upper surface of the chassis 20.

The gripping member 51 may be a pneumatic vacuum gripper, the item processing device 10 comprising a vacuum source arranged inside the chassis 20 and in fluid communication with the gripping member 51. The vacuum source may be a vacuum pump such as a turbine pump or a vane pump, or a Venturi pump. The turbine pump produces a high rate of air flow, but a low level of vacuum. This type of pump is suitable for gripping porous objects. In contrast, the vane pump produces a low rate of air flow, but a high level of vacuum. The Venturi pump comprises a compressor producing compressed air. The acceleration of the compressed air in a pipe creates a vacuum. The rate of the air flow is low, but the level of vacuum is high. Alternatively, the gripping member 51 may be a mechanical gripper provided with fingers for gripping the item.

The robotic arm 50 may be mounted on the chassis 20 closer to the front side 21 than to the rear side 22. Mounting the robotic arm 50 at the front allows easier access to the interior volume of the container 110 containing the item to be gripped. The heaviest elements of the device, such as the compressor, are then arranged at the rear side 22. In addition, the chassis 20 may have a centre of gravity that is closer to the rear side 22 than to the front side 21. The rearward positioning of the centre of gravity thus prevents the order preparation station from tipping over when the robotic arm 50 is moved.

The support structure 30 may be articulated so as to pivot, preferably freely (i.e. without mechanical assistance, without being motorized, and without being constrained in its movement), relative to the chassis 20 about a first axis A1. The first axis may extend along the second direction X2. The mobile support structure may be moved between the deployed configuration CD and the retracted configuration CE by pivoting relative to the chassis 20 about the first axis A1: in particular, in a first direction in order to transition from the deployed configuration CD to the retracted configuration CE, and in a second direction, opposite to the first direction, in order to transition from the retracted configuration CE to the deployed configuration CD.

The support structure 30 may comprise at least one support arm 31; 32.

Said at least one support arm 31; 32 comprises a first segment 33 and a second segment 34, the second segment 34 being articulated so as to pivot, preferably freely, relative to the first segment 33 about a second axis A2. This makes it possible to further minimize the volume of the item processing device when the support structure 30 is in the retracted configuration CE. The second axis A2 may be parallel to the first axis A1. Therefore the second axis A2 may extend in the second direction X2.

The first segment 33 of each support arm 31; 32 may be articulated so as to pivot, preferably freely, relative to the chassis 20 about the first axis A1. More particularly, the first segment 33 of each support arm 31; 32 may be articulated so as to pivot about the first axis A1 relative to a respective vertical upright 20c of the chassis 20, and preferably a rear vertical upright 20c of the chassis 20, in particular at an upper end thereof. The first segment 33 of each support arm 31; 32 may have a first end and a second end, the first segment 33 being articulated so as to pivot at the first end relative to the chassis 20 on the first axis A1. The mobile structure may be moved between the deployed configuration CD and the retracted configuration CE by pivoting the first segment 33 of each arm 31; 32 relative to the chassis 20 about the first axis A1 (represented by the arrow PI in FIG. 1): in particular, in a first direction in order to transition from the deployed configuration CD to the retracted configuration CE, and in a second direction, opposite to the first direction, in order to transition from the retracted configuration CE to the deployed configuration CD. A locking mechanism may be provided between the first segment 33 and the chassis 20, adapted to block a relative movement between the first segment 33 and the chassis 20 when in the retracted configuration CE and/or in the deployed configuration CD. The locking mechanism may for example comprise an element (for example a plate) that is fixed, for example by screwing or bolting, to the chassis 20 and the first segment 33.

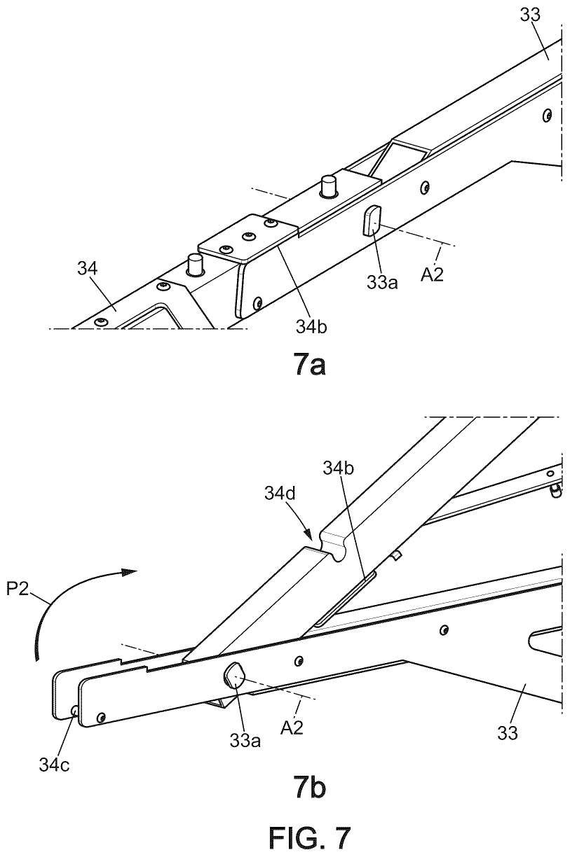

The second segment 34 of each support arm 31; 32 may have a first end and a second end, the second segment 34 being articulated so as to pivot at its first end relative to the first segment 33 of the respective support arm at its second end, on the second axis A2. As shown in FIG. 7, the first segment 33 may comprise a yoke at the second end which comprises two arms between which a first pivot shaft 33a extends along the second axis A2, on which the first end of the second segment 34 is pivotally mounted. The mobile support structure may be moved between the deployed configuration CD and the retracted configuration CE by pivoting the second segment 34 of each arm 31; 32 relative to the respective first segment 33, about the second axis A2 (represented by the arrow P2 in FIG. 1): in particular, in a first direction in order to transition from the deployed configuration CD to the retracted configuration CE, and in a second direction, opposite to the first direction, in order to transition from the retracted configuration CE to the deployed configuration CD. The second segment 34 may comprise a first stop member 34b adapted to bear against the first segment 33 (for example at the second end) when in the deployed configuration CD, to prevent the second segment 34 from pivoting in the second direction relative to the first segment 33 about the second axis A2 when in the deployed configuration CD. The first segment 33 may comprise a first stop shaft 34c extending between the arms of the yoke at the second end. The second segment 34 may be resting on the first stop shaft 34c (for example by engaging with a first groove 34d made in the first end of the second segment 34) in the deployed configuration CD, to prevent the second segment 34 from pivoting in the second direction about the second axis A2 relative to the first segment 33 when in the deployed configuration CD. According to an alternative embodiment, a locking mechanism may be provided between the first segment 33 and the second segment 34, adapted to block a relative movement between the first segment 33 and the second segment 34 when in the retracted configuration CE and/or in the deployed configuration CD.

The pivoting of the second segment 34 of each arm 31; 32 may be, in whole or in part, simultaneous or consecutive to the pivoting of the respective first segment 33. In the case where the first axis A1 and the second axis A2 are parallel, the first direction in which the second segment 34 of each arm 31; 32 pivots may be coincident with or be opposite to the direction in which the respective first segment 33 pivots.

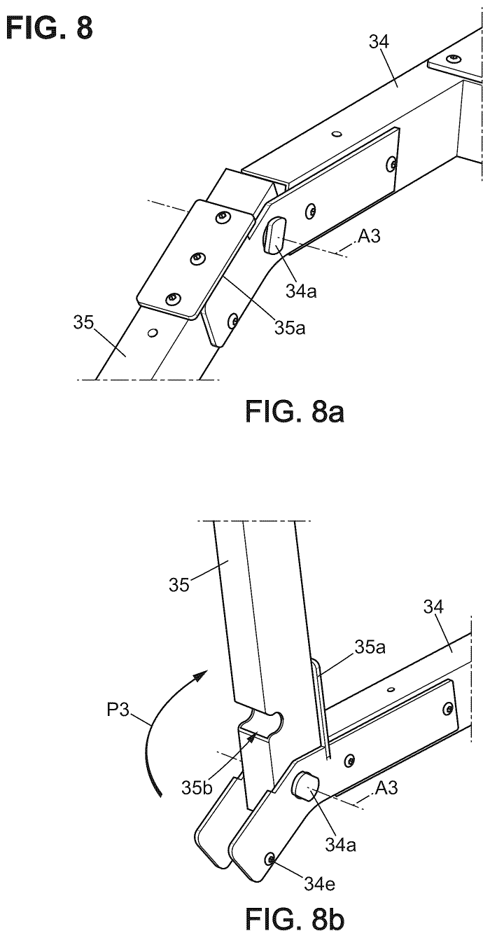

Each support arm 31; 32 may comprise a third segment 35. The third segment 35 of each support arm 31; 32 may be articulated so as to pivot, preferably freely, relative to the second segment 34 about a third axis A3. The third axis A3 may be parallel to the first axis A1 and/or to the second axis A2. Therefore the third axis A3 may extend in the second direction X2. The third segment 35 of each support arm 31; 32 may have a first end and a second end, the third segment 35 being articulated so as to pivot at its first end relative to the second segment 34 of the respective support arm at its second end, on the second axis A2. The second end of the third segment 35 of each support arm 31; 32 may be a free end. As shown in FIG. 8, the second segment 34 may comprise a yoke at the second end which comprises two arms between which a second pivot shaft 34a extends along the third axis A3, on which the first end of the third segment 35 is pivotally mounted.

The movable support structure may be moved between the deployed configuration CD and the retracted configuration CE by pivoting the third segment 35 of each arm 31; 32 relative to the respective second segment 34 about the third axis A3 (represented by the arrow P3 in FIG. 1): in particular, in a first direction in order to transition from the deployed configuration CD to the retracted configuration CE, and in a second direction, opposite to the first direction, in order to transition from the retracted configuration CE to the deployed configuration CD. The third segment 35 may comprise a second stop member 35a adapted to bear against the second segment 34 (for example at the second end) in the deployed configuration CD in order to prevent the second segment 34 from pivoting in the second direction about the third axis A3 relative to the second segment 34 when in the deployed configuration CD. The second segment 34 may comprise a second stop shaft 34e extending between the arms of the yoke at the second end. The third segment 35 may be resting on the second stop shaft 34e (for example by engaging with a second groove 35b made in the first end of the third segment 35) in the deployed configuration CD, to prevent the third segment 35 from pivoting in the second direction about the third axis A3 relative to the second segment 34 when in the deployed configuration CD. According to an alternative embodiment, a locking mechanism may be provided between the second segment 34 and the third segment 35, adapted to block a relative movement between the second segment 34 and the third segment 35 when in the retracted configuration CE and/or in the deployed configuration CD.

The pivoting of the third segment 35 of each arm 31; 32 may be, in whole or in part, simultaneous or consecutive to the pivoting of the respective second segment 34 and/or of the respective first segment 33. In the case where the first axis A1 and the third axis A3 are parallel, the first direction in which the third segment 35 of each arm 31; 32 pivots may be coincident with or be opposite to the direction in which the respective first segment 33 pivots. In the case where the second axis A2 and the third axis A3 are parallel, the first direction in which the third segment 35 of each arm 31; 32 pivots may be coincident with or be opposite to the direction in which the respective second segment 34 pivots.

“Segment” is understood to mean a solid section, i.e. with no movable joints. A segment

may be rectilinear, i.e. straight. It is not excluded that a segment may have any shape, for example arched or rounded. It is also not excluded that a segment may comprise several fixedly attached parts.

The support structure 30 may comprise a first support arm 31 and a second support arm 32 which are parallel to each other and spaced apart along the direction of the first axis A1 and second axis A2. The support structure 30 is thus more stable. This configuration is particularly preferred when the first axis and second axis are parallel to each other. The first support arm 31 and the second support arm 32 may be identical. The support structure 30 may further comprise at least one cross-member 36 extending between the first support arm 31 and the second support arm 32 along the direction of the first axis A1 and second axis A2. Such a cross-member 36 makes the support structure more resistant.

The transition from the retracted configuration CE to the deployed configuration CD may be carried out by a single operator.

As indicated above, in the deployed configuration CD of the support structure 30, the at least one camera 40 is positioned so as to be oriented towards a container 110 in proximity to the chassis 20. In other words, in the deployed configuration CD of the support structure 30, the at least one camera 40 is positioned so that it has an optical axis oriented towards a container 110 in proximity to the chassis 20. In particular, in the deployed configuration CD of the support structure 30, the at least one camera 40 may be oriented towards the front side 21 of the chassis 20.

In the deployed configuration CD of the support structure 30, the at least one camera 40 may be arranged substantially facing the bottom of a container 110 in proximity to the chassis 20. In the case where the bottom of the container 110 is horizontal (i.e. flat), the at least one camera 40 may be arranged substantially vertically above the container 110 in the deployed configuration CD of the support structure 30. In other words, in the deployed configuration CD of the support structure 30, an optical axis of the at least one camera 40 may be vertical or close to vertical, when the container is arranged on a horizontal plane.

More generally, the optical axis of the at least one camera 40 may be perpendicular or substantially perpendicular to the plane formed by the bottom of the container. This makes it possible to improve the captured image of the interior volume of the container 110.

Attaching the camera(s) 40 to the support structure 30 facilitates the installation of the item processing device 10 in the warehouse, while ensuring that the camera(s) 40 are correctly positioned after deployment of the support structure. The extrinsic calibration of the cameras 40, i.e. the relative positioning of the cameras with respect to their environment and in particular with respect to the robotic arm, is thereby facilitated. The at least one camera 40 may be attached to said at least one cross-member 36.

The item processing device 10 may comprise a plurality of cameras 40, each capable of capturing an image of the internal volume of a respective container 110 placed in proximity to the chassis 20.

When the support structure 30 is in the deployed configuration CD, a first camera 40 may be oriented toward the front side 21 of the chassis 20 in order to capture an image of the internal volume of a first container 110 comprising one or more items to be gripped, and a second camera 40 may be oriented toward the front side 21 of the chassis 20 in order to capture an image of the internal volume of a second container 110 in which an item is to be placed.

Thus, the item processing device may have a depth P in the first direction X1 which is smaller when the support structure 30 is in the retracted configuration CE than when it is in the deployed configuration CD. Similarly, the item processing device may have a height H in a vertical direction which is smaller when the support structure 30 is in the retracted configuration CE than when it is in the deployed configuration CD.

Furthermore, the item processing device may have a volume, when the support structure 30 is in the retracted configuration CE, which makes it suitable for insertion into a container 110 of parallelepipedal shape of standard dimensions, in particular 20 feet or 40 feet. This may be a cargo container 110 having standardized dimensions according to ISO 668. In particular, a container 110 that is 20 feet (6.1 m) or 40 feet (12.2 m) long (also called a “dry container”) may have a height H of 8.5 feet (2.62 m) or 9.5 feet (2.92 m), and a width of 8 feet (2.44 m), as well as a minimum door opening that is 2.28 m wide and 2.26 m high H. The item processing device 10 may then be loaded into a cargo transport container 110 in its retracted position and unloaded in a warehouse in a “ready-to-use” state by transitioning it from the retracted position to the deployed position.

The item processing device 10 may comprise a control unit configured to control the robotic arm 50 and to process a signal received from the at least one camera 40 so as to identify items in the containers 110 and/or to determine the location of items in the containers 110. The control unit may be arranged within the chassis 20.

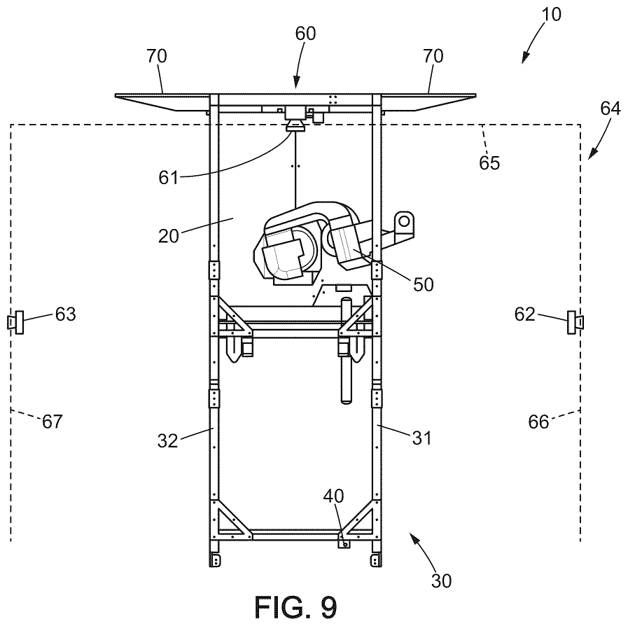

As shown in FIG. 9, the item processing device 10 may also comprise a system of safety sensors 60 which is configured to project a light curtain 64 and to detect a crossing of the light curtain 64 by an object and/or an operator. The system of sensors may further be configured to generate a command to interrupt the robotic arm 50, and/or a command for a light and/or sound signal, in the event that a crossing of the light curtain 64 is detected. Thus, when an operator or an object crosses or intercepts the light curtain 64, the robotic arm 50 stops and/or a light and/or sound signal may be triggered.

Such a system of safety sensors 60 is advantageously quick to install.

The light curtain 64 may comprise a central beam 65 extending transversely at a rear side 22 of the chassis 20, opposite the front side 21 in the first direction X1, and a pair of side beams each extending in the first direction X1 and arranged, transversely to the first direction X1, on each side of the chassis 20. In other words, the pair of side beams comprises a first side beam 66 extending in the first direction X1 which is arranged facing the first lateral side 23 of the chassis 20, and a second side beam 67 extending in the first direction X1 which is arranged facing the second lateral side 24 of the chassis 20.

The system of safety sensors 60 may comprise one or more lidar (“Light Detection And Ranging”) sensors, preferably adapted to emit a rotating beam over an angular range of at least 270°, in particular 360°. The system of safety sensors 60 may comprise a central sensor 61 mounted on the chassis 20 at the rear side 22, and a pair of lateral sensors arranged, transversely to the first direction X1, on each side of the chassis 20. In other words, the pair of lateral sensors may comprise a first lateral sensor 62 arranged facing the first lateral side 23 of the chassis 20, and a second lateral sensor 63 arranged facing the second lateral side 24 of the chassis 20. The lateral sensors may be connected to the support structure 30, in particular by a respective connecting tab. More particularly, the first lateral sensor 62 may be connected to the first support arm 31 and the second lateral sensor 63 may be connected to the second support arm 32.

Again for safety purposes, the item processing device 10 may comprise a protective panel 70 mounted on the chassis 20 at the rear side 22. The protective panel 70 makes it possible to reinforce the safety of the system by preventing an operator from approaching the working area of the robotic arm 50 too quickly. The panel also provides security for the dead zone of the sensors. The protective panel 70 may extend perpendicularly to the first direction X1.

The item processing device 10 as described above may have a weight that is less than or equal to 700 kg, advantageously less than or equal to 600 kg. The item processing device 10 thus has a weight which allows moving it around by pulling it manually, for example by means of a manual pallet truck, without exceeding the legal load limits, in particular those for horizontal pulling.

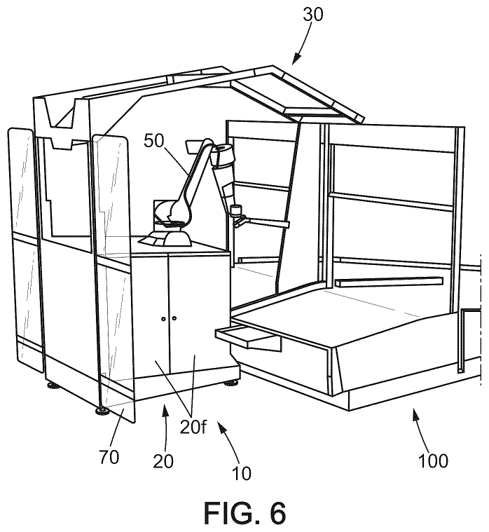

FIG. 6 comprises a logistics warehouse assembly comprising an item processing device 10 as described above, and a raising ramp 100. The raising ramp 100 is configured to allow a motorized vehicle to bring the at least one container 110 in proximity to the chassis 20 (so that the robotic arm 50 is able to grasp an item from and/or place an item in the internal volume of the container 110. This avoids the use of heavy and bulky conveyors. The ramp 100 may be adapted to accommodate one or more motorized vehicles. The vehicles may be “automated guided vehicles” (AGV). For this purpose, the vehicles may comprise on-board means of guidance, adapted for automated guidance. The motorized vehicles may be adapted for transporting a container 110. The ramp 100 may face the front side 21 of the chassis 20 of the item processing device 10.

1. A mobile item processing device comprising:
a chassis,
a robotic arm mounted on the chassis and provided with a gripping member at its end, the robotic arm being configured to grasp an item from and/or place an item in an internal volume of at least one container arranged in proximity to the chassis,
a support structure mounted on the chassis,
at least one camera fixed to the support structure,
characterized in that the support structure is movable between a deployed configuration in which the camera is capable of capturing an image of the internal volume of the container, and a retracted configuration in which the item processing device occupies a smaller volume in comparison to the deployed configuration.

2. The mobile item processing device according to claim 1, wherein the support structure is articulated so as to pivot relative to the chassis about a first axis.

3. The mobile item processing device according to claim 1, wherein the support structure comprises at least one support arm which comprises a first segment and a second segment, the second segment being articulated so as to pivot relative to the first segment about a second axis.

4. The mobile item processing device according to claim 3, wherein the support structure is articulated so as to pivot relative to the chassis about a first axis and wherein the first axis and the second axis are parallel, the support structure comprising a first support arm and a second support arm which are parallel to each other and spaced apart along the direction of the first axis and second axis.

5. The mobile item processing device according to claim 4, wherein the support structure comprises at least one cross-member extending between the first support arm and the second support arm along the direction of the first axis and second axis, the at least one camera preferably being attached to the at least one cross-member.

6. The mobile item processing device according to claim 1, wherein the chassis has, in a first direction, a front side configured to face the at least one container and a rear side that is opposite the front side in the first direction, the robotic arm being mounted on the chassis such that it is closer to the front side than to the rear side, the chassis preferably having a centre of gravity that is closer to the rear side than to the front side.

7. The mobile item processing device according to claim 6, which has a depth in the first direction that is smaller when the support structure is in the retracted configuration than when it is in the deployed configuration.

8. The mobile item processing device according to claim 1, which has a height in a vertical direction that is smaller when the support structure is in the retracted configuration than when it is in the deployed configuration.

9. The mobile item processing device according to claim 1, which has a volume when the support structure is in the retracted configuration that renders it suitable for insertion into a container of parallelepipedal shape and standard dimensions, in particular 20 feet or 40 feet.

10. The mobile item processing device according to claim 1, wherein the gripping member is a pneumatic vacuum gripper, the item processing device comprising a vacuum source arranged inside the chassis and in fluid communication with the gripping member.

11. The mobile item processing device according to claim 1, comprising a control unit configured to control the robotic arm and to process a signal received from the at least one camera so as to identify items in the containers and/or determine the location of items in the containers, the control unit being arranged inside the chassis.

12. The mobile item processing device according to claim 1, wherein the chassis comprises at least one lower recess and/or a pair of holes, adapted to receive the prongs of a lifting fork.

13. The mobile item processing device according to claim 1, comprising a system of safety sensors which is configured to project a light curtain and to detect a crossing of the light curtain by an object and/or an operator.

14. The mobile item processing device according to claim 13, wherein the chassis has, in a first direction, a front side configured to face the at least one container and a rear side that is opposite the front side in the first direction, the robotic arm being mounted on the chassis such that it is closer to the front side than to the rear side, the chassis preferably having a centre of gravity that is closer to the rear side than to the front side wherein the light curtain comprises:
a central beam extending transversely at the rear side of the chassis which is opposite the front side in the first direction,
a pair of side beams each extending in the first direction and arranged, transversely to the first direction, on each side of the chassis.

15. The mobile item processing device according to claim 1, wherein the chassis has, in a first direction, a front side configured to face the at least one container and a rear side that is opposite the front side in the first direction, the robotic arm being mounted on the chassis such that it is closer to the front side than to the rear side, the chassis preferably having a centre of gravity that is closer to the rear side than to the front side, the item processing device comprising a protective panel mounted on the chassis at the rear side.

16. The mobile item processing device according to claim 1, having a weight that is less than or equal to 700 kg.

17. A logistics warehouse assembly comprising the mobile item processing device according to claim 1 and a raising ramp, the raising ramp being configured to allow a motorized vehicle to bring the at least one container in proximity to the chassis so that the robotic arm is able to grasp an item from and/or place an item in the internal volume of the container.

18. The logistics warehouse assembly according to claim 17, comprising a container arranged in proximity to the chassis of the item processing device, the at least one camera being arranged facing the bottom of the container when the support structure is in the deployed configuration.
